(19) United States
(12) Patent Application Publication
(10) Pub. No.: US 2021/0197329 A1
(43) Pub. Date: Jul. 1, 2021

(54) PARTS FIXTURE FOR ROBOT MACHINING AND ROBOT MACHINING SYSTEM

(71) Applicant: YUANMENG PRECISION TECHNOLOGY (SHENZHEN) INSTITUTE, Shenzhen (CN)

(72) Inventors: Qing LIU, Shenzhen (CN); Junqi LI, Shenzhen (CN); Yongfei LAI, Shenzhen (CN); Yan NIE, Shenzhen (CN)

(73) Assignee: YUANMENG PRECISION TECHNOLOGY (SHENZHEN) INSTITUTE, Shenzhen (CN)

(21) Appl. No.: 16/075,329

(22) PCT Filed: Jan. 29, 2018
(86) PCT No.: PCT/CN2018/074441

§ 371 Date: Aug. 3, 2018

(30) Foreign Application Priority Data
Jul. 25, 2017 (CN) 201710613305.3

(51) Int. Cl. B23Q 3/06

(52) U.S. Cl. CPC B23Q 3/06

(57) ABSTRACT

A Parts fixture for robot machining and a robot machining system, includes a base plate for connecting with a robot machining platform, and a profiling surface disposed at the base plate for placing parts to be machined. The profiling surface has the same shape as the parts to be machined, and an edge of the base plate is provided with a pressing block for pressing the parts to be machined. The profiling surface can be completely matched with the parts to be machined, it ensures that the bottom of the parts to be machined is supported during the machining, so that the parts to be machined does not vibrate during the machining Therefore the machining accuracy of the parts to be machined can meet the machining requirements.

### TECHNICAL FIELD

The present application pertains to technical field of robot, and more particularly to a parts fixture for robot machining and a robot machining system.

### BACKGROUND

In the machining of parts, it is usually necessary to fix the parts to be machined in a correct position to ensure the smooth machining of the parts. Therefore, the fixture is a very important device in the process of parts machining Generally speaking, in any process of the crafting process, a device for quickly, conveniently, and safely mounting a part can be called a fixture, which is most common in the machining of a numerically controlled machine tool. When machining parts on a machine tool, in order to achieve the specified technical requirements on the surface of the parts, the parts must be assembled and clamped before machining With the gradual maturity of robotic technology, especially industrial robotic technology, more and more industrial robots are used for machining parts and automating the machining of parts.

However, at present, when the parts are machined, the universal combination fixture is used to fix the parts. Since the universal combination fixture has a simple structure and the fixing is very simple, the fixture and the parts to be machined cannot be in good contact, and thus the rigidity of the parts cannot be ensured when machined, so that the parts will vibrate during the machining process, and resulting in low machining accuracy and unable to meet the machining requirements.

The above shortcomings need to be improved.

### SUMMARY

An object of the embodiments of the present application is to provide a parts fixture for robot machining in order to solve the technical problem in the prior art that the fixture and the parts to be machined cannot be in good contact, and resulting in low machining accuracy and unable to meet the machining requirements.

In order to solve the above technical problem, the technical solution adopted by the embodiment of the present application is: providing a parts fixture for robot machining, comprising: a base plate for connecting with a robot machining platform, and a profiling surface disposed at the base plate for placing parts to be machined, the profiling surface has the same shape as the parts to be machined, and an edge of the base plate is provided with a pressing block for pressing the parts to be machined.

Further, the base plate comprises a first edge, a second edge, a third edge and a fourth edge, the first edge is opposite to the third edge, and the second edge is opposite to the fourth edge.

Further, a positioning block for positioning the robot is further disposed on the base plate.

Further, the positioning block is disposed at a middle of the first edge.

Further, the positioning block is a cube, and the corner of the cube is a sharp corner.

Further, the number of the pressing blocks is six, the first edge and the third edge are respectively distributed with two pressing blocks, and the second edge and the fourth edge are respectively distributed with one pressing block.

Further, the pressing block presses against the edge of the parts to be machined.

Further, a contacting surface of the pressing block contacting the parts to be machined is a profiling curved surface having the same shape as that at the contacting position of the parts to be machined.

Further, an edge of the base plate is provided with a connecting hole, and the base plate is connected to the robot machining platform through the connecting hole.

Further, the first edge, the second edge, the third edge and the fourth edge are respectively distributed with four connection holes.

Further, the connecting hole is a countersunk hole.

It is also an object of embodiments of the present application to provide a robotic machining system, comprising: the above-described parts fixture for robot machining.

The beneficial effect of the parts fixture for robot machining provided by embodiments of the present application is that since the shape of the profiling surface is the same as the shape of the parts to be machined, when the parts to be machined is placed on the profiling surface and fixed by the pressing block, the profiling surface can be completely matched with the parts to be machined, it ensures that the bottom of the parts to be machined is supported during the machining, so that the parts to be machined does not vibrate during the machining, therefore the machining accuracy of the parts to be machined can meet the machining requirements.

### BRIEF DESCRIPTION OF THE DRAWINGS

In order to make the technical solutions in the embodiments of the present application clearer, the accompanying drawings to be used in the embodiments and the description of the prior art will be briefly introduced below, it is apparent that the drawings in the following description are merely some embodiments of the present application and that other drawings may be obtained by those skilled in the field without departing from the inventive nature of the application.

FIG. 1 is a schematic structural view 1 of a parts fixture for robot machining according to an embodiment of the present application;

FIG. 2 is a schematic structural view 2 of a parts fixture for robot machining according to an embodiment of the present application;

FIG. 3 an installation process of a parts fixture for robot machining according to an embodiment of the present application;

FIG. 4 is a flowchart of machining parts to be machined according to an embodiment of the present application.

In the drawings, the following reference numerals are used:
1—base plate; 11—first edge; 12—second edge;
13—third edge; 14—fourth edge; 2—profiling surface;
3—pressing block; 4—position block; 5—connecting hole.

### DETAILED DESCRIPTION OF THE EMBODIMENTS

In order to make the technical problems to be solved, technical solutions, and beneficial effects of the present application clearer and more understandable, the present application will be further described in detail hereinafter with reference to the accompanying drawings and embodiments. It should be understood that the embodiments described herein are only intended to illustrate but not to limit the present application.

It is noted that when a component is referred to as being “fixed to” or “disposed on” another component, it can be directly or indirectly on another component. When a component is referred to as being “connected to” another component, it can be directly or indirectly connected to another component. In addition, the terms “first” and “second” are for illustrative purposes only and should not be construed as indicating or implying a relative importance or implicitly indicating the quantity of technical features indicated. Therefore, a feature that defines “first” and “second” may expressly or implicitly include one or more of the features. In the description of the present application, “multiple” means two or more than two, unless otherwise specifically defined.

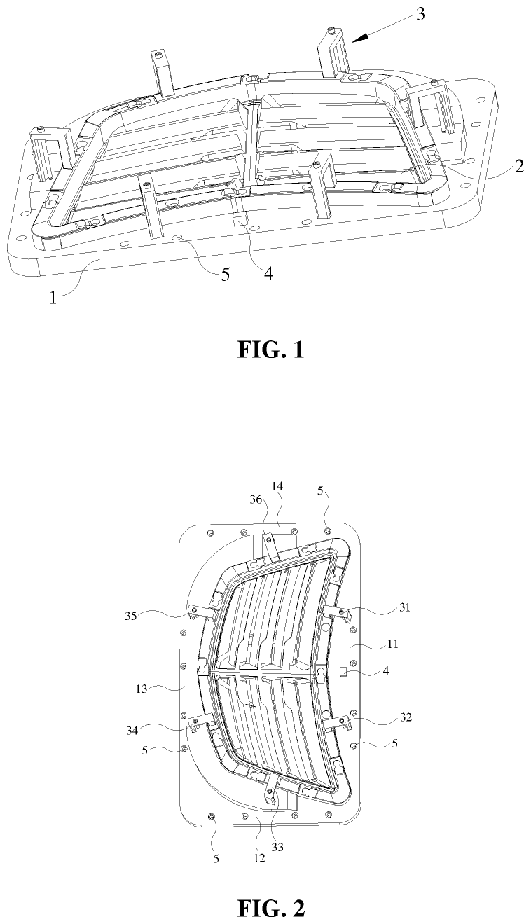

Please refer to FIG. 1 and FIG. 2, a parts fixture for robot machining comprises a base plate 1 for connecting with a robot machining platform, and a profiling surface 2 disposed at the base plate 1 for placing parts to be machined, a profiling surface 2 has the same shape as the parts to be machined, the profiling surface 2 is provided in the middle of an upper surface of the base plate 1, and an edge of the base plate 1 is provided with a pressing block 3 for pressing the parts to be machined.

The working principle of the parts fixture for robot machining provided by the embodiment is as follows: firstly, the base plate 1 is connected with the robot machining platform to fix the fixture on the robot machining platform; then the parts to be machined is placed on the profiling surface 2, so that the parts to be machined is matched to the profiling surface 2; then the parts to be machined is pressed by the pressing block 3 disposed around the profiling surface 2, so that the parts to be machined and the profiling surface 2 are completely matched; when the parts to be machined is fixed in the fixture, the robot starts to machine the parts to be machined.

The advantage of this arrangement is that since the shape of the profiling surface 2 is the same as the shape of the parts to be machined, when the parts to be machined is placed on the profiling surface 2 and fixed by the pressing block 3, the profiling surface 2 can completely matched with the parts to be machined, it ensures that the bottom of the parts to be machined is supported during the machining, so that the parts to be machined does not vibrate during the machining, therefore the machining accuracy of the parts to be machined can meet the machining requirements.

In the machining of parts, especially thin-walled parts, the parts fixture for robot machining provided by the embodiment is suitable for machining parts, especially thin-wall parts, and the material is aluminum alloy thereof. In one embodiment, the fixture can also be made of other materials.

Further, the base plate 1 comprises a first edge 11, a second edge 12, a third edge 13 and a fourth edge 14, the first edge 11 is opposite to the third edge 13, and the second edge 12 is opposite to the fourth edge 14.

Further, the base plate 1 is further provided with a positioning block 4 for positioning the robot, and the positioning block 4 is disposed at the middle of the first edge 11. In other embodiments, the positioning block 4 can be located at other positions on the upper surface of the base plate 1. When the robot is machining, firstly, it is positioned by the positioning block 4 disposed on the base plate 1, and at the same time, the coordinate system of the parts to be machined is determined, and then the movement track of when the robot machines the parts to be machined is planned, and then machining the parts to be machined. When the fixture is positioned by the positioning block 4, the fixture can be positioned by a three-point positioning method, or the fixture can be positioned by other positioning methods. The feature for the positioning of the robot usually needs to maintain a sharp corner. Therefore, the positioning block 4 in this embodiment is a cube, and the corners of the cube are sharp corners. In other embodiments, the positioning block 4 can be other shapes with sharp corners, for example, a cuboid or the like.

Further, the number of the pressing blocks 3 is six, the first edge 11 and the third edge 13 are respectively distributed with two pressing blocks 3, and the second edge 12 and the fourth edge 14 are respectively distributed with a pressing block 3, and the pressing block 3 presses the edge of the parts to be machined. This is because the robot cannot press the pressing blocks 3 during the machining process to machine the parts to be machined, so the pressing block 3 should minimize the area of the parts to be machined which is pressed while ensuring that the parts to be machined are well fixed.

Further, a contact surface of the pressing block 3 in contact with the parts to be machined is a profiling curved surface, and the shapes of the contact surfaces of the six pressing blocks 3 are respectively the same as the shape of the contact position at the parts to be machined. This arrangement is in order to make the pressing block 3 can match with the parts to be machined better when the pressing block 3 is in contact with the parts to be machined, thereby better ensuring that the parts to be machined does not vibrate during machining Since the contact surfaces of the six pressing blocks 3 are profiling surfaces designed according to the shape of the contact position of the parts to be machined in contact therewith, therefore the shapes of the contact surfaces of the six pressing blocks 3 are not the same, and the order of the six pressing blocks 3 cannot be changed at will, therefore the six pressing blocks 3 are numbered in the present embodiment, and the positions of the pressing blocks 3 on the base plate are numbered accordingly, for example, the six pressing blocks 3 may be sequentially numbered as the first pressing block 31, the second pressing block 32, the third pressing block 33, the fourth pressing block 34, the fifth pressing block 35 and the sixth pressing block 36, and the positions of the pressing blocks 3 on the base plate are sequentially numbered as the first pressing block position, a second pressing block position, a third pressing block position, a fourth pressing block position, a fifth pressing block position and a sixth pressing block position, and corresponding the first pressing block 31 to the first pressing block position, corresponding the second pressing block 32 to the second pressing block position, corresponding the third pressing block 33 to the third pressing block position, corresponding the fourth pressing block 34 to the fourth pressing block position, corresponding the fifth pressing block 35 to the fifth pressing block position, corresponding the sixth pressing block 36 to the sixth pressing block position. Each of the pressing blocks 3 corresponds to a corresponding number to prevent the contact surfaces of the pressing blocks 3 from being mismatched with the corresponding positions of the parts to be machined due to the replacement of the blocks 3 in order.

Further, the first edge 11, the second edge 12, the third edge 13 and the fourth edge 14 of the base plate 1 are provided with connecting holes 5, and the base plate 1 is connected to the robot machining platform through the connecting holes 5. In the embodiment, the first edge 11, the second edge 12, the third edge 13 and the fourth edge 14 of the base plate 1 are distributed with four connecting holes 5, and the connecting holes 5 are countersunk holes, and each connecting hole 5 is provided with a screw is, and the base plate 1 and the robot machining platform are connected by a screw. The connection hole 5 is set as a countersunk hole, which can avoid a protrusion of an upper end of the screw after the installation is completed, and ensuring that the installation plane is flatness. In one embodiment, the position and number of connecting holes 5 can be set as desired.

It is also an object of the present embodiment to provide a robot machining system comprising the above-described parts fixture for robot machining.

The beneficial effects of the parts fixture for robot machining provided by this embodiment are:

(1) Since the shape of the profiling surface 2 is the same as the shape of the parts to be machined, when the parts to be machined is placed on the profiling surface 2 and fixed by the pressing block 3, the profiling surface 2 can completely match with the parts to be machined, it ensures that the bottom of the parts to be machined is supported during the machining, so that the parts to be machined does not vibrate during the machining, therefore the machining accuracy of the parts to be machined can meet the machining requirements.

(2) Since the positioning block 4 is provided on the base plate 1, the robot can accurately position the parts to be machined;

(3) The contact surface of the pressing block 3 in contact with the parts to be machined is a profiling curved surface, so that the pressing block 3 can completely match with the parts to be machined when during the contact, so as to better ensure that the parts to be machined does not vibrate during the machining;

(4) The four edges of the base plate 1 are provided with connecting holes, which makes the fixture more stable when mounted on the robot machining platform.

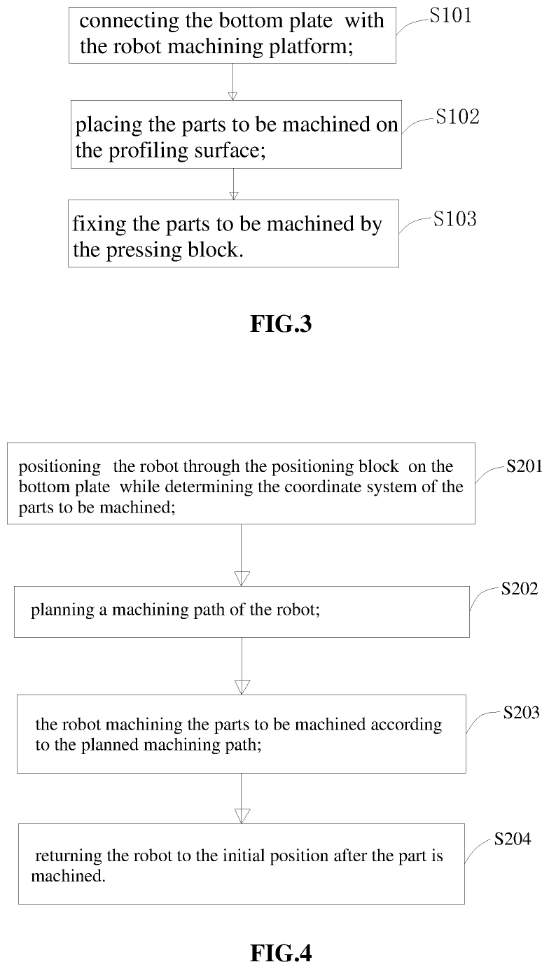

Please refer to FIG. 3, the method for installing the parts fixture for robot machining provided by the present embodiment is as follows:

Step S101: connecting the base plate 1 to the robot machining platform, specifically: placing the base plate 1 on the robot machining platform, and fixing the base plate 1 on the robot machining platform by the screw coordinating the connecting hole 5 on the base plate 1;

Step S102: placing the parts to be machined on the profiling surface 2, and making the parts to be machined completely match to the profiling surface 2;

Step S103: fixing the parts to be machined by the pressing block, specifically: placing the six pressing blocks 3 in the corresponding positions on the base plate and placing the pressing blocks 3 according to the number, and pressing the edges of the parts to be machined with the pressing block 3.

In one embodiment, the parts to be machined may also be mounted on the profiling surface 2 before the base plate 1 is fixed to the robotic machining platform.

Please refer to FIG. 4, after the parts to be machined are mounted on the parts fixture, the robot begins to machine the parts to be machined. The machining steps are as follows:

Step S201: positioning the robot through the positioning block 4 on the base plate 1 while determining the coordinate system of the parts to be machined;

Step S202: planning a machining path of the robot;

Step S203: the robot machining the parts to be machined according to the planned machining path;

Step S204: returning the robot to the initial position after the part is machined.

During the robot machining process, the planned robot machining path needs to ensure that the spindle of the robot does not collide with the fixture.

In the robot machining process, the robot can adjust the angle of the cutter,

In the case where the compact 3 is not disassembled, the inner and outer types of the parts to be machined are machined at one time, thereby improving the efficiency of the part processing.

After the machining of the robot is finished, remove the parts to get the processed parts.

The aforementioned embodiments are only preferred embodiments of the present application, and are not intended to limit the present application. Any modification, equivalent replacement, improvement, and so on, which are made within the spirit and the principle of the present application, should be comprised in the scope of the present application.

1-12. (canceled)

13. A parts fixture for robot machining, comprising:
a base plate for connecting with a robot machining platform, and a profiling surface disposed at the base plate for placing parts to be machined; wherein the profiling surface has the same shape as the parts to be machined, and an edge of the base plate is provided with a pressing block for pressing the parts to be machined.

14. The parts fixture for robot machining of claim 13, wherein the base plate comprises a first edge, a second edge, a third edge and a fourth edge, wherein the first edge is opposite to the third edge, and the second edge is opposite to the fourth edge.

15. The parts fixture for robot machining of claim 14, wherein the base plate is further provided with a positioning block for positioning the robot.

16. The parts fixture for robot machining of claim 15, wherein the positioning block is disposed at a middle of the first edge.

17. The parts fixture for robot machining of claim 15, wherein the positioning block is a cube, and a corner of the cube is a sharp corner.

18. The parts fixture for robot machining of claim 14, wherein the number of the pressing blocks is six, the first edge and the third edge are respectively distributed with two pressing blocks, and the second edge and the fourth edge are respectively distributed with one pressing block.

19. The parts fixture for robot machining of claim 13, wherein the pressing block presses against the edge of the parts to be machined.

20. The parts fixture for robot machining of claim 13, wherein a contacting surface of the pressing block contacting the parts to be machined is a profiling curved surface having the same shape as that at the contacting position of the parts to be machined.

21. The parts fixture for robot machining of claim 14 wherein an edge of the base plate is provided with a connecting hole and the base plate is connected to the robot machining platform through the connecting hole.

22. The parts fixture for robot machining of claim 21, wherein the first edge, the second edge, the third edge and the fourth edge are respectively distributed with four connection holes.

23. The parts fixture for robot machining of claim 21, wherein the connecting hole is a countersunk hole.

24. A robotic machining system, comprising the parts fixture for robot machining according to any one of claim 13.
